(19) United States
(12) Patent Application Publication
(10) Pub. No.: US 2024/0318030 A1
(43) Pub. Date: Sep. 26, 2024

(54) ANTI-ICING AND ANTI-FROSTING COATING COMPOSITE

(71) Applicant: The Hong Kong University of Science and Technology, Hong Kong (CN)

(72) Inventors: Shuhuai YAO, Hong Kong (CN); Tik SIN, Hong Kong (CN); Ho Yin CHUNG, Hong Kong (CN)

(21) Appl. No.: 18/602,101

(22) Filed: Mar. 12, 2024

Related U.S. Application Data
(60) Provisional application No. 63/491,085, filed on Mar. 20, 2023.

(51) Int. Cl. C09D 143/04; C08F 30/08; C08K 3/28; C09D 7/63; C09D 7/80

(52) U.S. Cl. CPC C09D 143/04; C08F 30/08; C08K 3/28; C09D 7/63; C09D 7/80; C08K 2201/003

(57) ABSTRACT

A coating composite including an outer slippery interface layer disposed on a surface of a photothermal layer, wherein the outer slippery interface layer includes a first poly(dialkylsiloxane) and an oil; and the photothermal layer includes photothermal nanoparticles and a second poly(dialkylsiloxane), a kit including the coating composite precursors, and methods of preparing the coating composite. The coating composite exhibits anti-icing and anti-frosting properties.

### CROSS-REFERENCE TO RELATED APPLICATIONS

The present application claims priority from U.S. Provisional Patent Application No. 63/491,085, filed on Mar. 20, 2023, which is hereby incorporated by reference in its entirety.

### STATEMENT REGARDING PRIOR DISCLOSURES BY THE INVENTORS OR JOINT INVENTORS UNDER 37 CFR 1.77(b)(6)

Part of the present invention was disclosed in a paper published in Advanced Materials Technologies, Volume 8, Issue 24, 2300839 (doi.org/10.1002/admt.202300839) on Nov. 21, 2023. This paper is a grace period inventor-originated disclosure disclosed within one year before the filing date of this application and falls within the exceptions defined under 35 USC §102(b)(1). This paper is hereby incorporated by reference in its entirety.

### TECHNICAL FIELD

Provided herein is an anti-icing and anti-frosting coating composite, a kit comprising coating composite precursors, and methods of preparing the coating composite.

### BACKGROUND

Existing anti-icing and anti-frosting coatings that are based on photothermal effect, low interfacial toughness surface, superhydrophobic surface (SHS), or slippery liquid-infused porous surface (SLIPS) typically lack satisfactory durability and cannot be applied to surfaces in a scalable fashion, which has limited their use in practical applications.

Known anti-icing and anti-frosting coatings including low interfacial toughness surface, SHS, and SLIPS exhibit a number of disadvantages. SHS utilizes micro/nanostructure to provide a Cassie-Baxter wetting state that reduces the interfacial contact between water (ice) and substrates. However, the performance deteriorates after icing/deicing cycles, and SHS-based coatings cannot be applied in humid environments. SLIPS-based coatings provide a slippery layer that utilizes microstructures to mechanically store the slippery liquid. Although the slippery liquid (often times an oil) can prevent direct contact with the substrate, the slippery liquid layer is metastable and consequently can be depleted after a low number of cycles of use. The low interfacial toughness surface utilizes polymer coating to reduce the bonding energy with ice, which reduces the detachment force of ice. However, current fabrication techniques make it challenging to apply on upside-down structures. In summary, these anti-icing/frosting coatings viability and applicability in real situations are limited by the environment, durability, cost, and fabrication procedure of the coating. Therefore, there is a need for improved coating anti-icing and anti-frosting that addresses at least some of the short comings in the art.

### SUMMARY

The coating composite described herein integrates photothermal nanoparticles and slippery liquid that provide both the photothermal effect and slippery interface. The coating's photothermal conversion efficiency is up to 96%, which can passively heat the coated surface with the presence of solar energy. Additionally, the slippery effect helps to reduce adhesion and wettability so that ice and frost have less cohesion and affinity to the surface. The coating provided herein synergizes both mechanisms without sacrificing either mechanism and as a result, the coating can further reduce icing and frosting compared to a single-mechanism coating. Moreover, the coating is mechanically and chemically durable, which makes it a robust and feasible coating that could be applied in real situations.

In a first aspect, the present disclosure provides a coating composite comprising: an outer slippery interface layer disposed on a surface of a photothermal layer, wherein the outer slippery interface layer comprises a first poly(dialkylsiloxane) and an oil; and the photothermal layer comprises photothermal nanoparticles and a second poly(dialkylsiloxane).

In certain embodiments, the oil comprises a perfluorinated oil, a silicone oil, a C₁₂-C₂₀ alkane, a mineral oil, a plant oil, or a mixture thereof.

In certain embodiments, the oil comprises a silicone oil, a mineral oil, a C₁₂-C₂₀ alkane, a plant oil or a mixture thereof.

In certain embodiments, the oil comprises a silicone oil.

In certain embodiments, the first and the second poly(dialkylsiloxane) independently comprise a poly(C₁-C₆)alkylsiloxane.

In certain embodiments, the first and the second poly(dialkylsiloxane) comprise polydimethylsiloxane.

In certain embodiments, the photothermal nanoparticles comprise plasmonic metal nanoparticles, semiconductor nanoparticles, carbon nanotube nanoparticles, graphene nanoparticles, graphene oxide nanoparticles, carbon black, polyaniline nanoparticles, polypyrrole nanoparticles, or a mixture thereof.

In certain embodiments, the photothermal nanoparticles are plasmonic metal nanoparticles, semiconductor nanoparticles, or a mixture thereof.

In certain embodiments, the photothermal nanoparticles comprise silver nanoparticles, gold nanoparticles, palladium nanoparticles, titanium dioxide nanoparticles, titanium nitride nanoparticles, silicon carbide nanoparticles, or a mixture thereof.

In certain embodiments, the photothermal nanoparticles comprise titanium nitride nanoparticles.

In certain embodiments, the oil and the first poly(dialkylsiloxane) are present in the outer slippery interface layer in a mass ratio of 0.15:1 to 0.45:1, respectively; and the photothermal nanoparticles and the second poly(dialkylsiloxane) are present in the photothermal layer in a mass ratio of 5:95 to 2:3, respectively.

In certain embodiments, the outer slippery interface layer comprises polydimethylsiloxane and mineral oil; and the photothermal layer comprises titanium nitride nanoparticles and polydimethylsiloxane.

In certain embodiments, the mineral oil and the polydimethylsiloxane are present in the outer slippery interface layer in a mass ratio of 1:4 to 1:3, respectively; and the titanium nitride nanoparticles and the polydimethylsiloxane are present in the photothermal layer in a mass ratio of 1:9 to 2:3, respectively.

In a second aspect, provided herein is a method of preparing the coating composite described herein, the method comprising: contacting a first polymerizable poly(dialkylsiloxane) precursor, a first crosslinking agent, photothermal nanoparticles, and a curing agent in a first solvent on a surface of a substrate thereby forming an uncured photothermal layer; curing the uncured photothermal layer thereby forming the photothermal layer; contacting a second polymerizable poly(dialkylsiloxane) precursor, a second crosslinking agent, an oil, and a curing agent in a second solvent on a surface of the photothermal layer thereby forming an uncured outer slippery interface layer; and curing the uncured outer slippery interface layer thereby forming the coating composite.

In certain embodiments, each of the first and the second polymerizable poly(dialkylsiloxane) precursor independently comprises a vinyl terminated poly(dialkylsiloxane).

In certain embodiments, each of the first and the second crosslinking agent independently comprises a polydialkylhydrogensiloxane.

In certain embodiments, each of the first and the second solvent comprises a volatile organic solvent.

In certain embodiments, the oil is mineral oil, each of the first and the second polymerizable poly(dialkylsiloxane) precursors comprises a vinyl terminated polydimethylsiloxane, the photothermal nanoparticles are titanium nitride nanoparticles, and the first and the second solvent comprise a volatile organic solvent.

In a third aspect, provided herein is a kit for preparing the coating composite described herein, the kit comprising: a first container and a second container, wherein the first container comprises a first polymerizable poly(dialkylsiloxane) precursor, photothermal nanoparticles, and a first solvent; and the second container comprises a crosslinking agent, an oil, and a second solvent.

In certain embodiments, the second container further comprises a curing agent; or the kit further comprises a third container comprising a curing agent.

### BRIEF DESCRIPTION OF THE DRAWINGS

The foregoing aspects and many of the attendant advantages of this invention will become more readily appreciated and understood by reference to the following detailed description, when taken in conjunction with the accompanying drawings.

FIG. 1 depicts a schematic illustration of photothermal oil-encapsulated matrix (POEM) coating composite fabrication processes according to certain embodiments described herein.

FIG. 2 depicts material characterization results of exemplary POEM coating composite. (a) POEM coating composite coated on a 50 cm×50 cm substrate show the coating's scalability. (b) Image of a delicate substrate (i) before and (ii) after coating. (c) The (i) top view and the (ii) side view scanning electron microscope (SEM) images of the POEM coating composite. (d) The images of (i) hysteresis angle and (ii) contact angle of 5 μl water droplet on the coating.

FIG. 3 depicts a schematic illustration of frosting test and the result under different wind speeds ((i) no wind, (ii) 0.3 ms⁻¹, and (iii) 0.6 ms⁻¹) and different solar intensities.

FIG. 4 depicts (a) photographic image of ice-adhesion test and (b) the measurement of different trials.

FIG. 5 depicts result of the abrasion test of an exemplary POEM coating composite.

FIG. 6 depicts experimental results of an acid corrosion test on the weight decreased of an aluminum plate coated with an exemplary POEM coating composite and uncoated aluminum plate.

FIG. 7 depicts experimental results of a seawater corrosion test on contact angle and hysteresis angle in

[symbol]

### DETAILED DESCRIPTION

### Definitions

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs. terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited. but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

As used herein, “alkyl” refers to a straight-chain or branched saturated hydrocarbon group. Examples of alkyl groups include methyl (Me), ethyl (Et), propyl (e.g., n-propyl and isopropyl), butyl (e.g., n-butyl, iso-butyl, sec-butyl, tert-butyl), pentyl groups (e.g., 1-methylbutyl, 2-methylbutyl, iso-pentyl, tert-pentyl, 1,2-dimethylpropyl, neopentyl, and 1-ethylpropyl), hexyl groups, and the like. In various embodiments, an alkyl group can have 1 to 40 carbon atoms (i.e., C₁-C₄₀ alkyl group), for example, 1-30 carbon atoms (i.e., C₁-C₃₀ alkyl group). In some embodiments, an alkyl group can have 1 to 6 carbon atoms, and can be referred to as a “lower alkyl group.” Examples of lower alkyl groups include methyl, ethyl, propyl (e.g., n-propyl and isopropyl), and butyl groups (e.g., n-butyl, iso-butyl, sec-butyl, tert-butyl). In some embodiments, alkyl groups can be substituted as described herein. An alkyl group is generally not substituted with another alkyl group, an alkenyl group, or an alkynyl group.

As used herein, “cycloalkyl” by itself or as part of another substituent means, unless otherwise stated, a monocyclic hydrocarbon having between 3-12 carbon atoms in the ring system and includes hydrogen, straight chain, branched chain, and/or cyclic substituents. Exemplary cycloalkyls include cyclopropyl, cyclobutyl, cyclopentyl, cyclohexyl, cycloheptyl, and the like.

As used herein, “aryl” refers to an aromatic monocyclic hydrocarbon ring system or a polycyclic ring system in which two or more aromatic hydrocarbon rings are fused (i.e., having a bond in common with) together or at least one aromatic monocyclic hydrocarbon ring is fused to one or more cycloalkyl and/or cycloheteroalkyl rings. An aryl group can have 6 to 24 carbon atoms in its ring system (e.g., C6-24 aryl group), which can include multiple fused rings. In certain embodiments, a polycyclic aryl group can have 8 to 24 carbon atoms.

As used herein, the term “volatile organic solvent” refers to organic compounds having a boiling point of less than 250° C., such as less than 200° C., less than 150° C., less than 100° C., or less than 75° C.

The present disclosure provides a coating composite comprising: an outer slippery interface layer disposed on a surface of a photothermal layer, wherein the outer slippery interface layer comprises a first poly(dialkylsiloxane) and an oil; and the photothermal layer comprises photothermal nanoparticles and a second poly(dialkylsiloxane), wherein the first poly(dialkylsiloxane) and the second poly(dialkylsiloxane) are the same or different.

Each of the first poly(dialkylsiloxane) and the second poly(dialkylsiloxane) can independently comprise a poly[di(C₁-C₆)alkylsiloxane], a poly[di(C₁-C₅)alkylsiloxane], a poly[di(C₁-C₄)alkylsiloxane], a poly[di(C₁-C₃)alkylsiloxane], a poly[di(C₁-C₂)alkylsiloxane], or a mixture thereof. In certain embodiments, each of the first poly(dialkylsiloxane) and the second poly(dialkylsiloxane) comprises polydimethylsiloxane. In certain embodiments, the first poly(dialkylsiloxane) is prepared by curing a first polymerizable poly(dialkylsiloxane) precursor and a first crosslinking agent in the presence of a curing agent; and the second poly(dialkylsiloxane) is prepared by curing a second polymerizable poly(dialkylsiloxane) precursor and a second crosslinking agent in the presence of a curing agent.

The photothermal nanoparticles can be plasmonic metal nanoparticles, semiconductor nanoparticles, carbon-based nanoparticles, polymer-based nanoparticles, or a mixture thereof.

In certain embodiments, the plasmonic metal nanoparticles comprise Au, Ag, Cu, Pd, Pt, Rh, MnO₂, VO₂, TiNₓ, Al_{w} Ti_{z}N, ZrNₓ, Al_{w}Zr_{z}N, TiC, ZrC, TiNₓC_{y}, ZrNₓC_{y}, TiNₓO_{y}, ZrNₓO_{y}, TiN, ZrN, TiB₂, and ZrB₂, wherein 0<w<1, 0.5≤x≤1.5, 0≤y≤1, and 0 <<1.In certain embodiments, the plasmonic metal nanoparticles comprise TiN.

In certain embodiments, the semiconductor nanoparticles can comprise transition metal oxides, such as Fe₃0₄ and WO₃, and transition metal chalcogenides, such as CuS, Cu₂Se, WS₂, MoS₂, and CuFeS₂, and mixtures thereof.

In certain embodiments, the carbon-based nanoparticles comprise carbon nanotube particles, graphene nanoparticles, graphene oxide nanoparticles, graphite nanoparticles, carbon black nanoparticles, carbon dots, and mixtures thereof.

In certain embodiments, the polymer-based nanoparticles comprise polyaniline, polypyrrole, polythiophene, and mixtures thereof.

The oil can comprise a perfluorinated oil, a mineral oil, a synthetic oil, a plant oil, a higher alkane, or a mixture thereof.

In certain embodiments, the synthetic oil comprises a poly-α-olefin oil, a diester oil, a silicone oil, or a mixture thereof.

The higher alkane can be a C₁₂-C₂₀ alkane, C₁₂-C₁₈ alkane, C₁₂-C₁₆ alkane, or C₁₂-C₁₆ alkane, or a mixture thereof. Exemplary higher alkanes include, but are not limited to dodecane, tridecane, tetradecane, pentadecane, hexadecane, heptadecane, octadecane, nonadecane, and icosane.

In certain embodiments, the plant comprises olive oil, palm oil, soybean oil, canola oil, rapeseed oil, corn oil, peanut oil, coconut oil, cottonseed oil, palm oil, safflower oil, sesame oil, sunflower oil, almond oil, cashew oil, hazelnut oil, macadamia oil, pecan oil, pine nut oil, walnut oil, grapefruit seed oil, lemon oil, orange oil, apple seed oil, argan oil, avocado oil, cocoa butter, grape seed oil, marula oil, mustard oil, quinoa oil, shea butter, or a mixture thereof.

The oil and the first poly(dialkylsiloxane) can be present in the outer slippery interface layer in a mass ratio of 0.15:1 to 0.45:1, 0.20:1 to 0.45:1, 0.25:1 to 0.45:1, 0.30:1 to 0.45:1, 0.35:1 to 0.45:1, 0.40:1 to 0.45:1, 0.15:1 to 0.40:1, 0.15:1 to 0.35:1, 0.15:1 to 0.30:1, 0.15:1 to 0.25:1, 0.15:1 to 0.20:1, 0.2:1 to 0.4:1, 0.25:1 to 0.35:1, or 0.3:1 to 0.45:1, respectively. In certain embodiments, the oil and the first poly(dialkylsiloxane) are present in the outer slippery interface layer in a mass ratio of about 0.33 to about 1, respectively.

The photothermal nanoparticles and the second poly(dialkylsiloxane) can be present in the photothermal layer in a mass ratio of 0.05:1 to 0.4:1, 0.05:1 to 0.35:1, 0.05:1 to 0.3:1, 0.05:1 to 0.25:1, 0.05:1 to 0.2:1, 0.05:1 to 0.15:1, 0.05:1 to 0.1:1, 0.1:1 to 0.4:1, 0.15:1 to 0.4:1, 0.2:1 to 0.4:1, 0.25:1 to 0.4:1, 0.3:1 to 0.4:1, 0.35:1 to 0.4:1, 0.1:1 to 0.35:1, 0.15:1 to 0.3:1, or 0.2:1 to 0.25:1, respectively. In certain embodiments, the photothermal nanoparticles and the second poly(dialkylsiloxane) are present in the photothermal layer in a mass ratio of about 0.22 to about 1, respectively.

The average thickness of the outer slippery interface layer can range from 5-500 μm, 5-400 μm, 5-300 μm, 5-200 μm, 5-100 μm, 5-90 μm, 5-80 μm, 5-70 μm, 5-60 μm, 5-50 μm, 5-40 μm, 5-30 μm, 5-20 μm, 5-15 μm, 10-15 μm, 10-20 μm, 5-10 μm, 10-100 μm, 20-100 μm, 30-100 μm, 40-100 μm, 50-100 μm, 60-100 μm, 70-100 μm, 80-100 μm, 90-100 μm, 20-90 μm, 30-80 μm, 40-70 μm, or 50-60 um. In certain embodiments, the average thickness of the outer slippery interface layer is about 15 μm.

The average thickness of the photothermal layer can range from 5-500 μm, 5-400 μm, 5-300 μm, 5-200 μm, 5-100 μm, 5-90 μm, 5-80 μm, 5-70 μm, 5-60 μm, 5-50 μm, 5-40 μm, 5-30 μm, 5-20 μm, 5-15 μm, 10-15 μm, 10-20 μm, 5-10 μm, 10-100 μm, 20-100 μm, 30-100 μm, 40-100 μm, 50-100 μm, 60-100 μm, 70-100 μm, 80-100 μm, 90-100 μm, 20-90 μm, 30-80 μm, 40- 70 μm, or 50-60 μm.

In certain embodiments, the coating composite is disposed on a substrate, wherein the photothermal is disposed between the substrate and the outer slippery interface layer. The substrate is not particularly limited and can be any substrate for which anti-icing and anti-frosting properties are desired. Exemplary substrates include, but are not limited to, comprise a metal (e.g., aluminum copper, iron, and titanium), an alloy (e.g., aluminum alloy, titanium alloy, carbon steel, stainless steel, bronze, and brass), glass, diamond, a polymer (e.g., high density polyethylene, low density polyethylene, polypropylene, polystyrene, polyethylene terephthalate, polycarbonate, polylactic aid, polyvinyl chloride, and Teflon®), a ceramic (e.g., alumina, silica, titania, and zirconia), a wood, a textile, or a mixture thereof.

The present disclosure also provides a method of preparing the coating composite described herein, the method comprising: contacting a first polymerizable poly(dialkylsiloxane) precursor, a first crosslinking agent, photothermal nanoparticles, and a curing agent in a first solvent on a surface of a substrate thereby forming an uncured photothermal layer; curing the uncured photothermal layer thereby forming the photothermal layer; contacting a second polymerizable poly(dialkylsiloxane) precursor, a second crosslinking agent, an oil, and a curing agent in a second solvent on a surface of the photothermal layer thereby forming an uncured outer slippery interface layer; and curing the uncured outer slippery interface layer thereby forming the coating composite.

The type of substrate is not particularly limited and can comprise a metal (e.g., aluminum copper, iron, and titanium), an alloy (e.g., aluminum alloy, titanium alloy, carbon steel, stainless steel, bronze, and brass), glass, diamond, a polymer (e.g., high density polyethylene, low density polyethylene, polypropylene, polystyrene, polyethylene terephthalate, polycarbonate, polylactic aid, polyvinyl chloride, and Teflon®), or a ceramic (e.g., alumina, silica, titania, and zirconia).

Each of the first and second polymerizable poly(dialkylsiloxane) precursors can independently comprise a vinyl terminated poly[di(C₁-C₆)alkylsiloxane], a vinyl terminated poly[di(C₁-C₅)alkylsiloxane], a vinyl terminated poly[di(C₁-C₄)alkylsiloxane], a vinyl terminated poly[di(C₁-C₃)alkylsiloxane], a vinyl terminated poly[di(C₁-C₂)alkylsiloxane], or a mixture thereof. In certain embodiments, each of the first poly(dialkylsiloxane) and the second poly(dialkylsiloxane) comprises a vinyl terminated polydimethylsiloxane.

Each of the first and second crosslinking agents can independently comprise a poly[hydrogen(C₁-C₆)alkylsiloxane], a poly[hydrogen(C₁-C₅)alkylsiloxane], a poly[hydrogen(C₁-C₄)alkylsiloxane], a poly[hydrogen(C₁-C₃)alkylsiloxane], a poly[hydrogen(C₁-C₂)alkylsiloxane], or a mixture thereof. In certain embodiments, each of the first and second crosslinking agents comprise a poly[hydrogenmethylsiloxane].

The curing agent can comprise a hydrosilylation catalyst. Hydrosilylation catalysts can include, but are not limited to, catalysts including transition metals of Group VIII. These metals include, but are not limited to, palladium, rhodium, and platinum, as well as complexes of these metals. Examples of the hydrosilylation catalysts include platinum group metals alone, such as platinum (including platinum black), platinum (0) catalysts, such as Karstedt's catalyst, rhodium and palladium; platinum chlorides, chloroplatinic acids and chloroplatinates, such as H₂PtCl₄·nH₂O, H₂PtCl₆·nH₂O, NaHPtCl₆·nH₂O, KHPtCl₆·nH₂O, Na₂PtCl₆·nH₂O, K₂PtCl₄·nH₂O, PtCl₄·nH₂O, PtCl₂ and Na₂HPtCl₄·nH₂O, wherein n is an integer of 0 to 6.In certain embodiments, the catalyst is Karstedt's catalyst (platinum-divinyltetramethyldisiloxane complex).

Solvents useful in the compositions and methods described herein include solvents in which the oil, the first polymerizable poly(dialkylsiloxane) precursor, and the second polymerizable poly(dialkylsiloxane) precursor are at least partially soluble. Such solvents include, but are not limited to, organic solvents, such as aliphatic solvents, aromatic solvents, aliphatic ether solvents, aliphatic ketone solvents, aldehyde solvents, haloalkane solvents, haloaromatic solvents, dialkylsulfoxide solvents, and mixtures thereof. The selection of a suitable solvent is well within the skill of a person of ordinary skill in the art.

The use of a volatile organic solvent can reduce curing time. Typical volatile organic solvents include aliphatic solvents, such as pentane, hexane, heptane, octane, nonane, decane, undecane, petroleum ether, kerosene, and the like; aromatic solvents, such as benzene, toluene, naphthalene, xylene, cumene, mesitylene, and the like; chlorinated solvents, such as dichloromethane, 1,1-dichloroethane, 1,2-dichloroethane, tetrachloroethane, chlorobenzene, and the like; ketones, such as acetone, 2-butanone, 3,3-dimethylbutanone, methyl isobutyl ketone, and the like; ethers, such as tetrahydrofuran, tetrahydropyran, dibutyl ether, tertbutylmethylether, tetrahydrofuran, and the like; N,N-dimethylformamide (DMF); acetonitrile; and combinations thereof. In certain embodiments, the solvent is n-hexane.

In certain embodiments, the first and second poly(dialkylsiloxane)s are prepared using a commercially available two-component silicone elastomer kit sold under the tradename Sylgard® 184 available from Dow Corning Corp. and believed to contain in Component A: (1) >60 wt. % dimethylvinyl-terminated dimethyl siloxane; (2) 30-60 wt. % dimethylvinylated and trimethylated silica; (3) 1-5 wt. % tetra(trimethysiloxy)silane; and (4) 0.7 wt. % xylene; and in Component B: (1) 40-70 wt. % of dimethyl, methylhydrogen siloxane; (2) 15-40 wt. % of dimethylvinyl-terminated dimethyl siloxane; (3) 10-30 wt. % of dimethylvinylated and trimethylated silica; (4) tetramethyl tetravinyl cyclotetrasiloxane; (5) a platinum-based hydrosilation catalyst; and (6) 0.3 wt. % xylene.

In embodiments, in which the first and second poly(dialkylsiloxane)s are prepared using Sylgard® 184, Component A, Component B, photothermal nanoparticles and a solvent can be contacted on a substrate thereby forming thereby forming an uncured photothermal layer; curing the uncured photothermal layer thereby forming a photothermal layer; Component A, Component B, an oil, and solvent can be contacted on a surface of the photothermal layer thereby forming an uncured outer slippery interface layer; and curing the uncured outer slippery interface layer thereby forming the coating composite described herein.

The curing steps can comprise independently heating each of the uncured photothermal layer and the uncured outer slippery interface layer at 30-200° C., 40-200° C., 50-200° C., 60-200° C., 70-200° C., 80-200° C., 90-200° C., 100-200° C., 100-190° C., 100-180° C., 100-170° C., 100-160° C., 100-150° C., 100-140° C., 100-130° C., 100-120° C., 100-110° C., 110-150° C., 120-150° C., 130-150° C., or 140-150° C. In certain embodiments, the curing steps comprise independently heating each of the uncured photothermal layer and the uncured outer slippery interface layer at about 100° C. to about 150° C. The uncured photothermal layer and the uncured outer slippery interface layer can be heated for 5-30 minutes depending on the temperature used.

The present disclosure also provides a kit for preparing the coating composite described herein, the kit comprising: a first container and a second container, wherein the first container comprises a first polymerizable poly(dialkylsiloxane) precursor, photothermal nanoparticles, and a first solvent; and the second container comprises a crosslinking agent, an oil, and a second solvent, wherein the first polymerizable poly(dialkylsiloxane) precursor, the photothermal nanoparticles, the crosslinking agent, and the oil are each independently as described in any embodiment or combination of embodiments described herein; and the first and the second solvents are the same or different.

In certain embodiments, the second container further comprises a curing agent; or the kit further comprises a third container comprising a curing agent, wherein the curing agent is as described in any embodiment described herein.

In certain embodiments, the kit further comprises instructions for preparing the coating composite.

The first and second solvents can each independently comprise an organic solvent, such as aliphatic solvents, aromatic solvents, aliphatic ether solvents, aliphatic ketone solvents, aldehyde solvents, haloalkane solvents, haloaromatic solvents, dialkylsulfoxide solvents, and mixtures thereof.

In certain embodiments, the first and second solvents independent comprise an aliphatic solvents, such as pentane, hexane, heptane, octane, nonane, decane, undecane, petroleum ether, kerosene, and the like; aromatic solvents, such as benzene, toluene, naphthalene, xylene, cumene, mesitylene, and the like; chlorinated solvents, such as dichloromethane, 1,1-dichloroethane, 1,2-dichloroethane, tetrachloroethane, chlorobenzene, and the like; ketones, such as acetone, 2-butanone, 3,3-dimethylbutanone, methyl isobutyl ketone, and the like; ethers, such as tetrahydrofuran, tetrahydropyran, dibutyl ether, tertbutylmethylether, tetrahydrofuran, and the like; N,N-dimethylformamide (DMF); acetonitrile; or a combinations thereof. In certain embodiments, the first and second solvents comprise n-hexane.

The present disclosure further provides a kit for preparing the coating composite described herein, the kit comprising: a two-component Sylgard® 184 silicone elastomer kit, a first container comprising photothermal nanoparticles, a second container comprising an oil, wherein the photothermal nanoparticles and oil are each independently as described in any embodiment or combination of embodiments described herein.

The POEM coating composite is disclosed herein, which combines the photothermal effect and slippery interface. The coating can also be sprayed so it can be scalably applied to different complicated geometry and substrates.

POEM coating composite is a novel, cost-effective, and scalable coating that has high chemical and mechanical robustness. In certain embodiments the coating composite utilizes polydimethylsiloxane (PDMS) as the base material since it has excellent mechanical and optical properties that can allow light to pass through. Moreover, it is an organogel that has a high affinity with oil and it can absorb oil into the polymer matrix. With these properties, photothermal nanoparticles can be added to the matrix without sacrificing and the matrix can combine with oil to provide a durable slippery interface. These additives enable a photothermal effect and slippery interface, which are two mechanisms that can be used in anti-icing and anti-frosting.

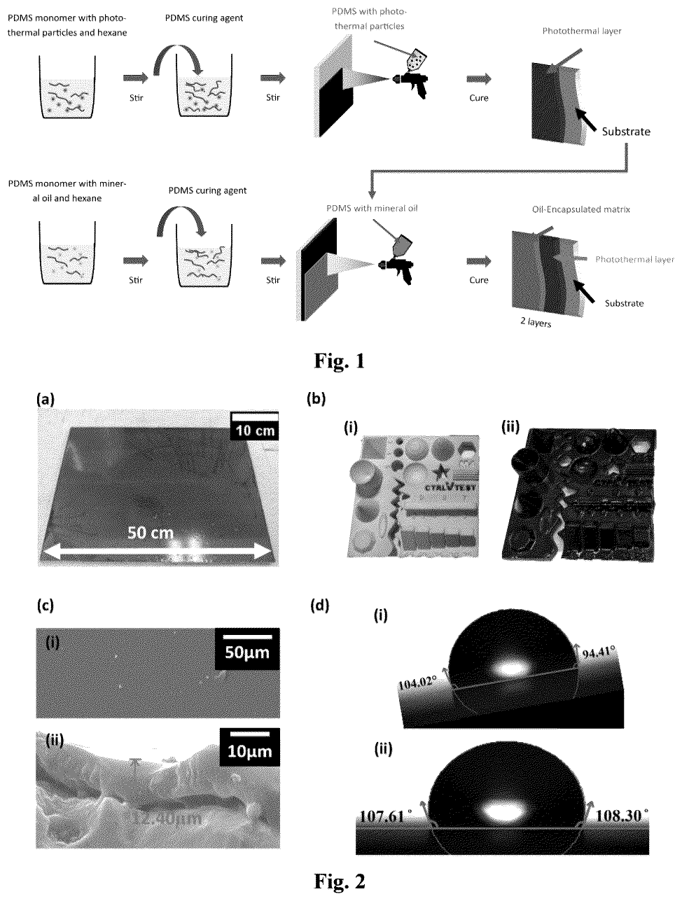

The fabrication of the novel coating strategy that comprises photothermal nanoparticles, oil, and PDMS matrix is separated into two parts: the inner photothermal layer and the outer slippery interface, which are illustrated in FIG. 1. The photothermal nanoparticles, such as titanium nitride nanoparticles, were first mixed under 1,000 rpm with PDMS monomer and hexane with a ratio of 0.22:1:1.1 to form the precure mixture for the inner layer. The precure mixture was then ultrasonicated for 15 minutes. Before spraying the mixture, PDMS curing agent was added and mixed under 1,000 rpm for 5 minutes. After spraying, the coating was cured under 100 to 150° C. for 30 to 5 minutes depending on the temperature.

Mineral oil was mixed under 1,000 rpm with PDMS monomer and hexane with a ratio of 0.33:1:1.1 to form the precure mixture for the outer layer. Before spraying the mixture, PDMS curing agent was added and mixed under 1,000 rpm for 5 minutes. After spraying, the coating was cured under 100 to 150° C. for 30 to 5 minutes depending on the temperature. After finishing both layers, POEM coating composite fabrication is finished and from the contact angle and hysteresis angle measurements, they proved that the coating is hydrophobic and has low adhesion with water droplets (FIG. 2).

### EXAMPLES

The novel coating integrates and synergizes both the photothermal effect and slippery interface, which was proved separately in other studies. Here, the coating demonstrates excellent anti-frosting and anti-icing performance by synergizing both mechanisms. Moreover, mechanical and chemical durability tests were performed to show the robustness of the coating.

### Example 1—Preparation of Exemplary POEM Coating Composite

An exemplary POEM coating composite was prepared in a two-step process in which the inner photothermal layer is first formed and the outer slippery interface layer is deposited thereon.

The inner photothermal layer was prepared by mixing a base solution (PDMS monomer (Sylgard® 184, Dow Corning): n-hexane=1:1.1 weight ratio) with TiN nanoparticles (<100 nm, Aladdin, China) in a 0.22:2.1 weight ratio and then stirred for an hour. Then, the solution was ultrasonicated for 15 minutes to reduce the aggregation of the nanoparticles. PDMS curing agent (Sylgard® 184, Dow Corning) with a 0.1:2.32 weight ratio to the solution was added and then stirred for 5 minutes to mix the curing agent with the PDMS monomer. After preparing the spray solution, it is sprayed with a force of 300 kPa onto the surface of the substrate at a moving speed of 25 mm s-1 using an air pump (UA-601 G, USTAR) and a spray gun with 0.5 mm orifice size (S-150, USTAR) and cured under 100° C. for 30 minutes. After curing, the photothermal nanoparticles will be trapped inside the PDMS polymer matrix. Due to the transparency of PDMS, light can pass through the matrix and reach the nanoparticles to trigger the photothermal effects.

The outer slippery interface layer is prepared from a base solution prepared by mixing PDMS monomer (Sylgard® 184, Dow Corning) with n-hexane (95%, RCI Labscan) with a 1:1.1 weight ratio and then stirring with magnetic bars at 1000 rpm for two hours. The n-hexane acts as a thinner of the PDMS to lower the viscosity. Then, mineral oil (M3516, Sigma Aldrich), the functional additives with a 0.33:2.1 weight ratio with the base solution, was added and stirred at 1000 rpm for an hour. After mixing, the PDMS/n-hexane/mineral oil mixture was formed. PDMS curing agent (Sylgard 184, Dow Corning) is then added to the mix in a 0.1:2.43 weight ratio and stirred for five minutes. The solution is sprayed with a force of 300 kPa on the substrate at a moving speed of 25 mm s-1 using an air pump (UA-601G, USTAR) and a spray gun with 0.5 mm orifice size (S-150, USTAR) and cured under 100° C. for 30 minutes. A curing temperature higher than the boiling point of n-hexane (≈69° C.) is required to ensure the n-hexane in the mixture is boiled away. A lower curing temperature leads to a longer curing process. Following the procedures above, a coating with a thickness of about 15 μm can be formed on the substrate (FIG. 2c(ii)). All procedures and equipment were the same throughout the sample preparation to reproduce the coating thickness (15±3) μm and roughness (≈40 nm). Our trials suggest that the optimal oil/PDMS weight ratio falls from 0.15:1 to 0.45:1. If the ratio is too low, the coating may not create a slippery interface, resulting in a texture similar to PDMS. While adding more oil can ensure a slippery interface, exceeding the limit can prevent the polymer matrix from curing and forming a coating on substrates.

### Example 2—Anti-Frosting Testing

Frost accretes on substrates when the surface temperature is lower than the freezing point of water. In the real outdoor environment, water vapor in the air will condense on the cold substrates and then freeze. The continuous process could build up weight and load on structures. Frost accretion tests were performed on POEM coating composite coated and uncoated aluminum cooling plates to examine the performance after applying the coating.

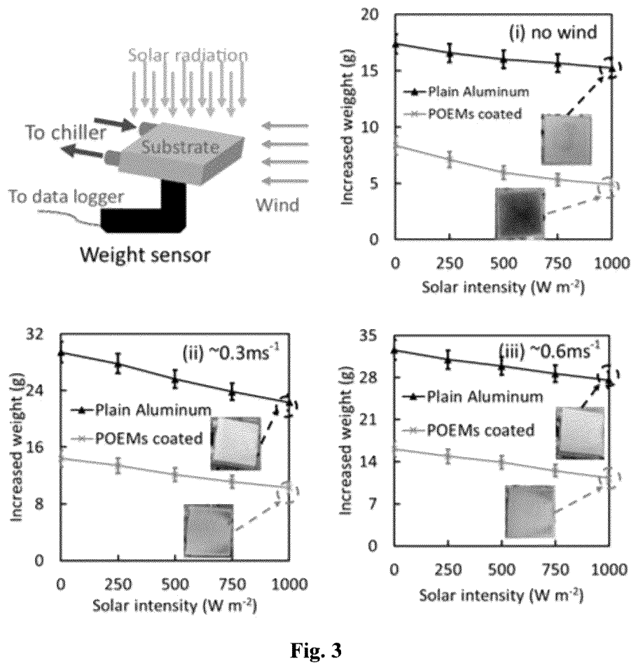

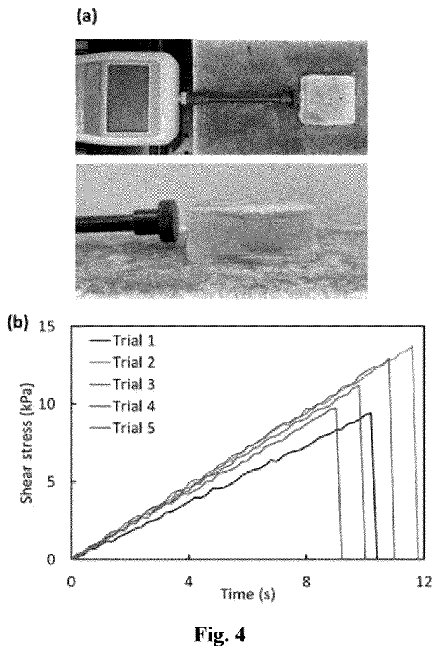

In the frost accretion test, the aluminum cooling plates were connected to a chiller that was set to −10° C. while the environment was in room conditions so the water vapor would condense rapidly due to the supercool condition. Weight sensors were placed under the plates to measure the weight change due to the accretion of frost. Vary wind speeds and solar intensities were applied to the surface to mimic the real situation. Every test was performed for 30 minutes and the weight gained on substrates were shown in FIG. 3. The results suggested that when there was no solar energy, that means only the slippery effect, the frost accretion can be reduced up to 51.9%. When the solar intensities increase, the synergy of both mechanisms further reduced the weight up to 67.8%.

### Example 3—Anti-Icing Testing

In cold areas, an iced surface would cause risks to pedestrians and vehicles since it would block the passways. Besides, houses and buildings need to remove the formed ice regularly to prevent collapse due to extra loading. However, the formed ice requires human power and machines to remove it from surfaces. Therefore, a low ice adhesion surface is preferred since it can reduce the effort and force required to remove the ice.

The anti-icing performance was demonstrated through an ice adhesion test. In the test, ice blocks were formed by placing a sample box on the testing surface (coated cooling plate) and adding deionized water inside. Then the cooling plate was maintained at −10° C. for the ice to form. After freezing and stabilizing for 15 minutes, a tensiometer was pushed against the ice with an actuator. The force was measured and divided by the contact surface area to obtain the detaching shear stress. The test was repeated 5 times, and the results are shown in FIG. 4. The average ice adhesion stress was 11.4 kPa.

### Example 4—Mechanical Durability

Mechanical durability is an essential criterion to quantify if the coating is robust and feasible in the real environment. When the coating is applied on the outer surface, dusty wind and sand may rub and scratch the coating. As a result, the coating's slipperiness and wettability may deteriorate under the circumstance. The coating must be mechanically durable or the lifetime will be short when applied to real situations.

An abrasion test was performed on a coated substrate by rubbing it on a 1600-grit sandpaper with 1.02kPa normal pressure. The contact angle and hysteresis angle were measured after every 10 abrasions to examine the change in wettability. The result in FIG. 5 suggested that there has been no significant change in wettability even after 100 abrasions, which suggested that the coating is mechanically stable.

### Example 5—Anti-Corrosion

In real situations, the coating may encounter acid rain or seawater corrosion. Acid rain with a low pH value may corrode the coating and the substrate, which affect the performance and structural rigidity. For seawater, since it contains ions that may have reactions with coatings, the performance would be altered by it. Therefore, the coating should be inert to both substances.

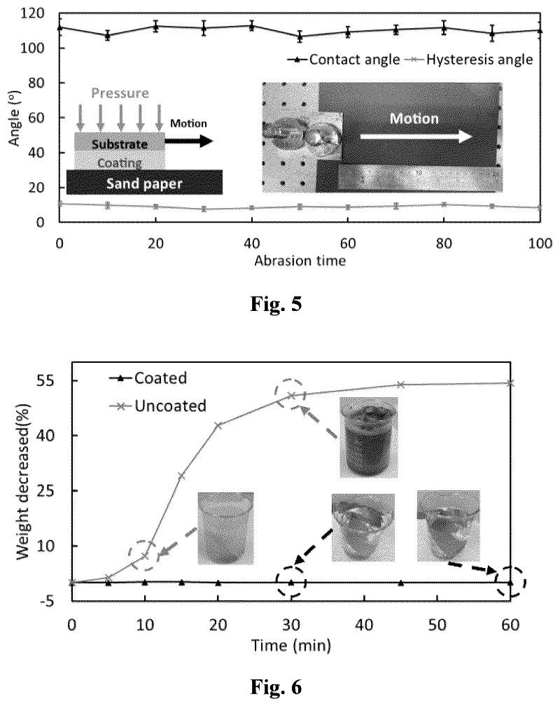

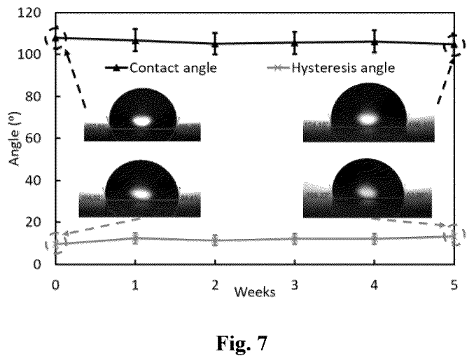

In the acid corrosion test, coated aluminum plates were put into 360ml 2M hydrochloric acid to examine the weight change due to acid corrosion. As a control comparison, an uncoated aluminum plate was also put into 360ml 2M hydrochloric acid. The weight was measured during the experiment and shown in FIG. 6. The coated substrate has no weight change under the acidic environment demonstrating that the coating prevents corrosion.

In a seawater corrosion test, POEM coating composite coated glass and uncoated glass were soaked in seawater for 5 weeks, and the contact angle and hysteresis angle were measured every week to examine the wettability. The results are shown in FIG. 7, which demonstrating that the coating's wettability has no significant change since the contact angle and hysteresis angle are maintained at a similar level to the initial value.

What is claimed is:

1. A coating composite comprising: an outer slippery interface layer disposed on a surface of a photothermal layer, wherein the outer slippery interface layer comprises a first poly(dialkylsiloxane) and an oil; and the photothermal layer comprises photothermal nanoparticles and a second poly(dialkylsiloxane).

2. The coating composite of claim 1, wherein the oil comprises a perfluorinated oil, a silicone oil, a C₁₂-C₂₀ alkane, a mineral oil, a plant oil, or a mixture thereof.

3. The coating composite of claim 1, wherein the oil comprises a silicone oil, a mineral oil, a C₁₂-C₂₀ alkane, a plant oil or a mixture thereof.

4. The coating composite of claim 1, wherein the oil comprises a silicone oil.

5. The coating composite of claim 1, wherein the first and the second poly(dialkylsiloxane) independently comprise a poly(C₁-C₆)alkylsiloxane.

6. The coating composite of claim 1, wherein the first and the second poly(dialkylsiloxane) comprise polydimethylsiloxane.

7. The coating composite of claim 1, wherein the photothermal nanoparticles comprise plasmonic metal nanoparticles, semiconductor nanoparticles, carbon nanotube nanoparticles, graphene nanoparticles, graphene oxide nanoparticles, carbon black, polyaniline nanoparticles, polypyrrole nanoparticles, or a mixture thereof.

8. The coating composite of claim 1, wherein the photothermal nanoparticles are plasmonic metal nanoparticles, semiconductor nanoparticles, or a mixture thereof.

9. The coating composite of claim 1, wherein the photothermal nanoparticles comprise silver nanoparticles, gold nanoparticles, palladium nanoparticles, titanium dioxide nanoparticles, titanium nitride nanoparticles, silicon carbide nanoparticles, or a mixture thereof.

10. The coating composite of claim 1, wherein the photothermal nanoparticles comprise titanium nitride nanoparticles.

11. The coating composite of claim 1, wherein the oil and the first poly(dialkylsiloxane) are present in the outer slippery interface layer in a mass ratio of 0.15:1 to 0.45:1, respectively; and the photothermal nanoparticles and the second poly(dialkylsiloxane) are present in the photothermal layer in a mass ratio of 5:95 to 2:3, respectively.

12. The coating composite of claim 1, wherein the outer slippery interface layer comprises polydimethylsiloxane and mineral oil; and the photothermal layer comprises titanium nitride nanoparticles and polydimethylsiloxane.

13. The coating composite of claim 12, wherein the mineral oil and the polydimethylsiloxane are present in the outer slippery interface layer in a mass ratio of 1:4 to 1:3, respectively; and the titanium nitride nanoparticles and the polydimethylsiloxane are present in the photothermal layer in a mass ratio of 1:9 to 2:3, respectively.

14. A method of preparing the coating composite of claim 1, the method comprising:
contacting a first polymerizable poly(dialkylsiloxane) precursor, a first crosslinking agent, photothermal nanoparticles, and a curing agent in a first solvent on a surface of a substrate thereby forming an uncured photothermal layer; curing the uncured photothermal layer thereby forming the photothermal layer;
contacting a second polymerizable poly(dialkylsiloxane) precursor, a second crosslinking agent, an oil, and a curing agent in a second solvent on a surface of the photothermal layer thereby forming an uncured outer slippery interface layer; and
curing the uncured outer slippery interface layer thereby forming the coating composite.

15. The method of claim 14, wherein each of the first and the second polymerizable poly(dialkylsiloxane) precursor independently comprises a vinyl terminated poly(dialkylsiloxane).

16. The method of claim 14, wherein each of the first and the second crosslinking agent independently comprises a polydialkylhydrogensiloxane.

17. The method of claim 14, each of the first and the second solvent comprises a volatile organic solvent.

18. The method of claim 14, wherein the oil is mineral oil, each of the first and the second polymerizable poly(dialkylsiloxane) precursors comprises a vinyl terminated polydimethylsiloxane, the photothermal nanoparticles are titanium nitride nanoparticles, and the first and the second solvent comprise a volatile organic solvent.

19. A kit for preparing the coating composite of claim 1, the kit comprising: a first container and a second container, wherein the first container comprises a first polymerizable poly(dialkylsiloxane) precursor, photothermal nanoparticles, and a first solvent; and the second container comprises a crosslinking agent, an oil, and a second solvent.

20. The kit of claim 19, wherein the second container further comprises a curing agent; or the kit further comprises a third container comprising a curing agent.
